(19) United States
(12) Patent Application Publication
(10) Pub. No.: US 2015/0137719 A1
(43) Pub. Date: May 21, 2015

(54) APPARATUS FOR CONTROLLING 3-PHASE MOTOR AND METHOD FOR MAINTAINING HIGH TORQUE THEREIN

(71) Applicant: MANDO CORPORATION, Pyeongtaek-si (KR)

(72) Inventor: Kyu Woong CHOI, Yongin-si (KR)

(21) Appl. No.: 14/308,206

(22) Filed: Jun. 18, 2014

(30) Foreign Application Priority Data
Nov. 20, 2013 (KR) 10-2013-0141554

(51) Int. Cl. H02P 6/10

(52) U.S. Cl. CPC H02P 6/10
USPC 318/400.15

(57) ABSTRACT

Provided are an apparatus for controlling a 3-phase motor and a method for maintaining a high torque therein, which are capable of preventing excessive heat generation in a coil, through which a phase current flows, by causing an AC current to flow in a specific phase when a 3-phase motor maintains a high torque. The apparatus for controlling the 3-phase motor includes: a sensor configured to sense torques flowing through three phases of the 3-phase motor; and a controller configured to determine whether the torques of the three phases, which are detected by the sensor, maintain a high torque, and to perform control such that, when it is determined that the detected torques maintain the high torque, a DC signal is applied to a specific phase among the three phases and an AC signal is applied to the other phases.

### CROSS-REFERENCE(S) TO RELATED APPLICATION

This application claims the benefit of Korean Patent Application No. 10-2013-0141554, filed on Nov. 20, 2013, in the Korean Intellectual Property Office, the contents of which are incorporated herein by reference in its entirety.

### BACKGROUND OF THE INVENTION

1. Field of the Invention

The present invention relates to an apparatus for controlling a 3-phase motor and a method for maintaining a high torque therein, and more particularly, to an apparatus for controlling a 3-phase motor and a method for maintaining a high torque therein, which are capable of preventing excessive heat generation in a coil, through which a phase current flows, by causing an AC current to flow in a specific phase when a 3-phase motor maintains a high torque.

2. Description of the Related Art

Generally, in order to control a motor drive of a vehicle, a drive of a 3-phase motor is controlled by switching an inverter in response to a pulse width modulation (PWM) signal. For example, as illustrated in FIG. 3, the PWM signal for switching the inverter is controlled such that the PWM signal is driven to maintain an ON state during 120° with respect to a first phase A_H, repeat an ON/OFF switching during 120° with respect to a second phase C_L, and output an ON signal during 120° with respect to a third phase B_H. A voltage is applied such that the second phase lags behind the first phase by 120° and the third phase leads the first phase by 120°.

A conventional apparatus for controlling a 3-phase motor is disclosed in Korean Patent Application Publication No. 10-2003-0050454 (published on Jun. 25, 2003, entitled “APPARATUS AND METHOD FOR CONTROLLING MOTOR OF HYBRID ELECTRIC VEHICLE”).

The conventional apparatuses for controlling a 3-phase motor, including the apparatus disclosed in Korean Patent Application Publication No. 10-2003-0050454, perform a drive control of a brushless direct current (BLDC) motor, which is used as a drive motor, by directly sensing a current of each phase and reducing a torque ripple in a low-speed section through a hysteresis current control, but have a problem that heat is excessively generated in a specific phase when a 3-phase motor maintains an output of a maximum torque (or high torque). For example, heat may be excessively generated in a specific phase if a driver of a vehicle mounted with a system such as an electronic brake system for generating a brake pressure by using a 3-phase motor may continuously step on a brake pedal to maintain a high-pressure brake force.

### CITATION LIST

### Patent Literature

Korean Patent Application Publication No. 10-2003-0050454 (published on Jun. 25, 2003), entitled “APPARATUS AND METHOD FOR CONTROLLING MOTOR OF HYBRID ELECTRIC VEHICLE”)

### SUMMARY OF THE INVENTION

An object of the present invention is to provide an apparatus for controlling a 3-phase motor and a method for maintaining a high torque therein, which are capable of preventing excessive heat generation in a coil, through which a phase current flows, by causing an AC current to flow in a specific phase when a 3-phase motor maintains a high torque.

According to an embodiment of the present invention, an apparatus for controlling a 3-phase motor includes: a sensor configured to sense torques flowing through three phases of the 3-phase motor; and a controller configured to determine whether the torques of the three phases, which are detected by the sensor, maintain a high torque, and to perform control such that, when it is determined that the detected torques maintain the high torque, a DC signal is applied to a specific phase among the three phases and an AC signal is applied to the other phases.

The controller may apply an AC voltage to a first phase requiring highest current among the three phases, apply an AC voltage to a third phase leading the first phase by 120°, and apply a DC voltage to a second phase lagging behind the first phase by 120°.

The controller may control magnitudes of the voltages applied to the 3-phase motor such that a total sum of the voltages of the first phase, the second phase, and the third phase becomes zero.

The AC voltages applied to the first phase and the third phase may be a sine wave.

According to another embodiment of the present invention, a method for maintaining a high torque in an apparatus for controlling a 3-phase motor includes: receiving torques flowing through the 3-phase motor; determining whether the received torques of three phases maintain a high torque; and performing control such that, when it is determined that the detected torques maintain the high torque, a DC signal is applied to a specific phase among the three phases and an AC signal is applied to the other phases.

In the controlling step, an AC voltage may be applied to a first phase requiring highest current among the three phases, an AC voltage may be applied to a third phase leading the first phase by 120°, and a DC voltage may be applied to a second phase lagging behind the first phase by 120°.

In the controlling step, magnitudes of the voltages applied to the 3-phase motor may be controlled such that a total sum of the voltages of the first phase, the second phase, and the third phase becomes zero.

### BRIEF DESCRIPTION OF THE DRAWINGS

FIG. 1 is a block diagram for describing an apparatus for controlling a 3-phase motor according to an embodiment of the present invention.

FIG. 2 is an operation flowchart for describing a method for maintaining a high torque in an apparatus for controlling a 3-phase motor according to an embodiment of the present invention.

FIG. 3 is a graph showing a voltage applied to a conventional 3-phase motor.

FIG. 4 is a graph showing a voltage applied to the 3-phase motor according to the present invention.

FIG. 5 is a graph showing a current flowing through the 3-phase motor.

FIG. 6 is a graph showing a control result of the apparatus for controlling the 3-phase motor according to the embodiment of the present invention.

### DETAILED DESCRIPTION OF EXEMPLARY EMBODIMENTS

Hereinafter, preferred embodiments of the present invention will be described below in detail with reference to the accompanying drawings.

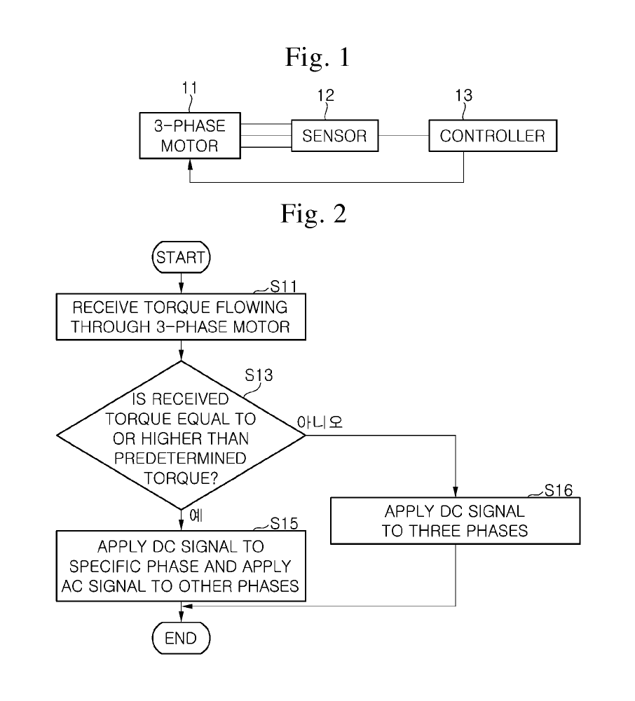

FIG. 1 is a block diagram for describing an apparatus for controlling a 3-phase motor according to an embodiment of the present invention.

Referring to FIG. 1, the apparatus for controlling the 3-phase motor according to the embodiment of the present invention a 3-phase motor 11, a sensor 12 for sensing a torque flowing through each phase of the 3-phase motor 11, and a controller 13 for adjusting a current level by applying an AC signal to a specific phase when the torque of each phase, which is sensed by the sensor 12, maintains a high torque.

The 3-phase motor 11 is braked and driven by a brake and an inverter, which are not illustrated. The 3-phase motor 11 may have three phases, that is, U, V and W, and be integrally formed with the brake. The brake is loosened until a current flows through a brake coil. The inverter includes a switching transistor and a transistor driving circuit.

The sensor 12 senses a torque flowing through each phase of the 3-phase motor 11. The sensor 12 senses a torque flowing through a first phase requiring the highest current, a torque flowing through a second phase lagging behind the first phase by 120°, and a torque flowing through a third phase leading the first phase by 120°. The sensor 12 may be a torque sensor for measuring a torque.

The controller 13 compares the detected torques of the first to third phases with a preset predetermined torque and determines whether the torque sensed by the sensor 12, for example, the torque of the first phase, is equal to or higher than the predetermined torque. That is, when it is determined that the torque of the first phase is equal to or higher than the predetermined torque, the controller 13 determines that a high torque has occurred in the first phase.

Furthermore, the controller 13 may further determine whether the torque is maintained for a predetermined time even when a high torque has occurred so as to prevent a current level adjustment with respect to the high torque that may temporarily occur.

In particular, the controller 13 provides a switch (not illustrated) with an AC signal (that is, a sine wave) for adjusting the current level when the high torque has occurred. The switch is switched such that an AC signal provided under the control of the controller 13 is applied to the first phase of the 3-phase motor 11, an AC signal having a phase leading the first phase by 120° is applied to the third phase of the 3-phase motor 11, and a DC signal is applied to the second phase of the 3-phase motor 11.

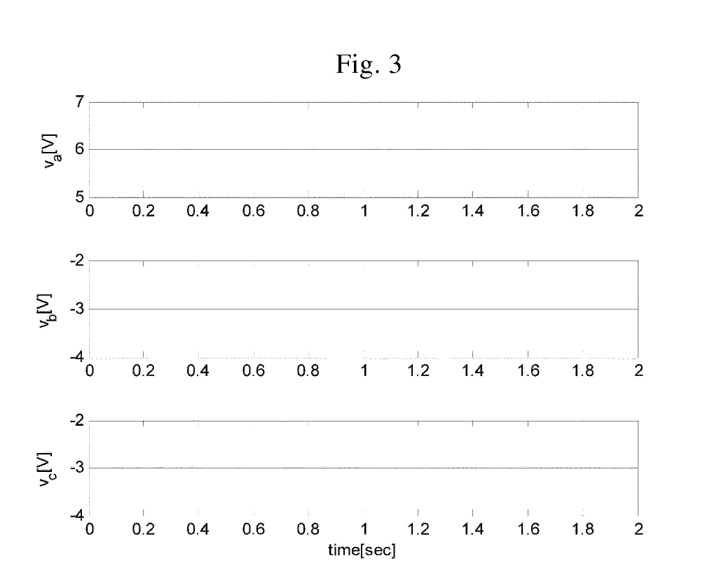

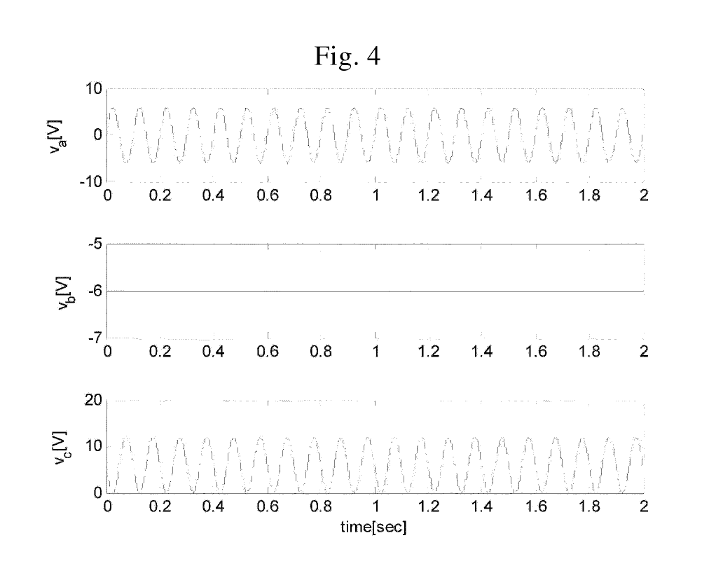

FIG. 3 is a graph showing voltages applied to the first to third phases when no high torque has occurred. FIG. 4 is a graph showing voltages applied to the first to third phases when the high torque has occurred. The magnitude of the voltage applied to the 3-phase motor 11 is controlled such that the total sum of the voltages applied to the first to third phases becomes zero.

Therefore, by applying an AC voltage to the other phases, instead of constantly maintaining the torque by applying a DC voltage to a specific phase among three phases of the 3-phase motor 11, it is possible to prevent heat from being excessively generated in the coil through which the phase current flows, and to extend a torque output maintaining time.

A method for maintaining a high torque in the apparatus for controlling the 3-phase motor, which has the above configuration, will be described below with reference to FIG. 2.

FIG. 2 is an operation flowchart for describing a method for maintaining a high torque in an apparatus for controlling a 3-phase motor according to an embodiment of the present invention.

The controller 13 receives the torque flowing through the 3-phase motor 11, which is detected by the sensor 12 connected to the 3-phase motor 11 (S11).

The controller 13 determines whether the received torque is equal to or higher than a predetermined torque (S13).

When it is determined in step S13 that the received torque is lower than the predetermined torque, the controller 13 performs control such that a DC signal is applied to three phases of the 3-phase motor 11 (S16).

When it is determined in step S13 that the received torque is equal to or higher than the predetermined torque, that is, when a high torque has occurred in one specific phase, for example, the first phase, among the three phases of the 3-phase motor 11, the controller 13 performs control such that a DC signal is applied to the specific phase and an AC signal is applied to the other phases (S15). More specifically, the controller 13 applies an AC voltage to the first phase, applies an AC voltage having a phase leading the first phase by 120° to the third phase, and applies a DC voltage to the second phase. At this time, the controller 13 adjusts the magnitudes of the voltages applied to the 3-phase motor 11, such that the total sum of the voltages applied to the first to third phases becomes zero.

In this manner, when the high torque is maintained in any one of the three phases of the 3-phase motor 11, the current level can be adjusted by applying the AC voltage to the preset second phase. Therefore, it is possible to solve the conventional problem that heat is excessively generated in a certain coil when the driver continuously steps on a brake pedal to maintain a high-pressure brake force.

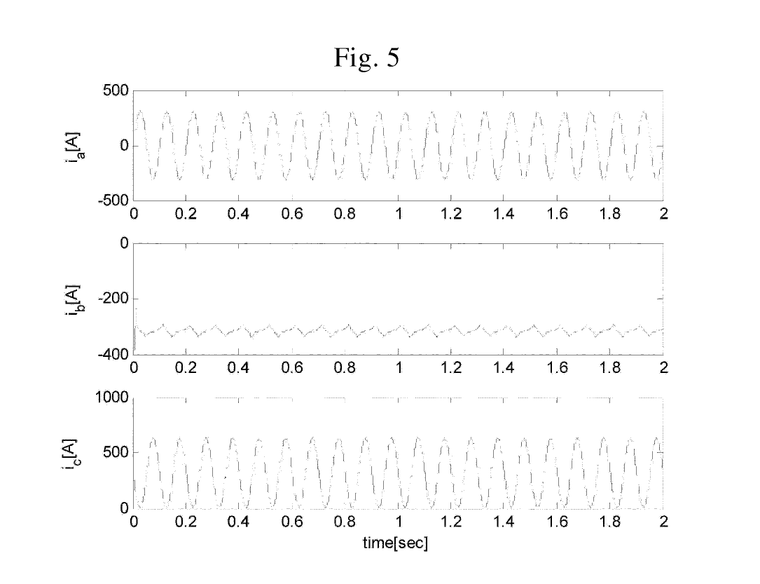

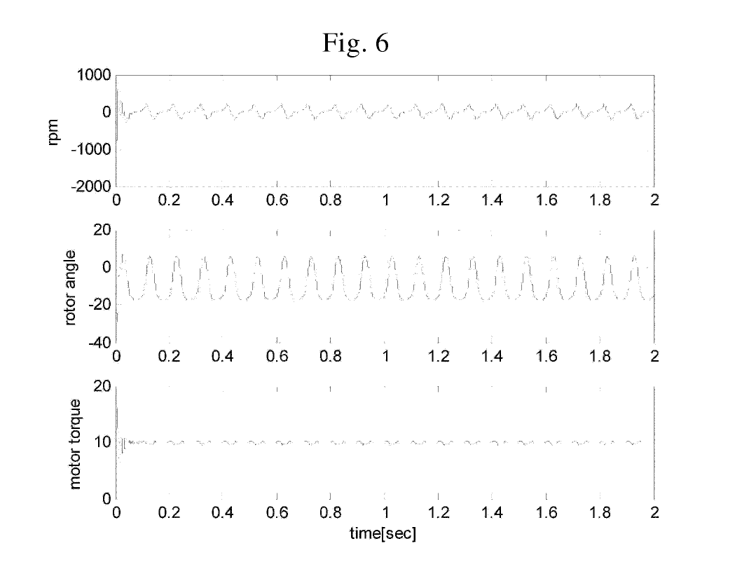

FIG. 5 is a graph showing a current flowing through the 3-phase motor. FIG. 6 is a graph showing the control result of the apparatus for controlling the 3-phase motor according to the embodiment of the present invention.

Even when the currents measured in the first phase (iₐ [A]) and the third phase (i_{c} [A]) are vibrated as illustrated in FIG. 5, the torque of the 3-phase motor 11 is not greatly vibrated as illustrated in FIG. 6. In addition, since the 3-phase motor 11 outputs a weight (10 Nm) applied to the outside while not moving, the same value as a situation where the force is balanced can be maintained. As can be seen from FIG. 6, although the angle of the 3-phase motor is vibrated, the corresponding amplitude is negligible when considering a reduction ratio of a reducer attached to the 3-phase motor.

According to the present invention, by causing an AC current to flow in a specific phase when the 3-phase motor maintains the high torque, it is possible to prevent excessive heat generation in the coil, through which the phase current flows, and to extend the torque output maintaining time.

Furthermore, according to the present invention, the magnitudes of the voltages applied to the 3-phase motor can be controlled such that the total sum of the reference voltages of the first to third phases applied to the 3-phase motor becomes zero.

While the embodiments of the present invention have been described with reference to the specific embodiments, it will be apparent to those skilled in the art that various changes and modifications may be made without departing from the spirit and scope of the invention as defined in the following claims.

DESCRIPTION OF REFERENCE NUMERALS

| | |
|---|---|
| 11: 3-phase motor | 12: sensor |
| 13: controller | |

What is claimed is:

1. An apparatus for controlling a 3-phase motor, comprising:
a sensor configured to sense torques flowing through three phases of the 3-phase motor; and
a controller configured to determine whether the torques of the three phases, which are detected by the sensor, maintain a high torque, and to perform control such that, when it is determined that the detected torques maintain the high torque, a DC signal is applied to a specific phase among the three phases and an AC signal is applied to the other phases.

2. The apparatus according to claim 1, wherein the controller applies an AC voltage to a first phase requiring highest current among the three phases, applies an AC voltage to a third phase leading the first phase by 120°, and applies a DC voltage to a second phase lagging behind the first phase by 120°.

3. The apparatus according to claim 2, wherein the controller controls magnitudes of the voltages applied to the 3-phase motor such that a total sum of the voltages of the first phase, the second phase, and the third phase becomes zero.

4. The apparatus according to claim 2, wherein the AC voltages applied to the first phase and the third phase are a sine wave.

5. A method for maintaining a high torque in an apparatus for controlling a 3-phase motor, the method comprising:
receiving torques flowing through the 3-phase motor;
determining whether the received torques of three phases maintain a high torque; and
performing control such that, when it is determined that the detected torques maintain the high torque, a DC signal is applied to a specific phase among the three phases and an AC signal is applied to the other phases.

6. The method according to claim 5, wherein in the controlling step, an AC voltage is applied to a first phase requiring highest current among the three phases, an AC voltage is applied to a third phase leading the first phase by 120°, and a DC voltage is applied to a second phase lagging behind the first phase by 120°.

7. The method according to claim 6, wherein in the controlling step, magnitudes of the voltages applied to the 3-phase motor are controlled such that a total sum of the voltages of the first phase, the second phase, and the third phase becomes zero.
